(19) United States
(12) Patent Application Publication
(10) Pub. No.: US 2025/0375729 A1
(43) Pub. Date: Dec. 11, 2025

(54) SYSTEMS FOR REMOVING CARBON DIOXIDE FROM A CARBON DIOXIDE CONTAINING GAS, AND RELATED METHODS

(71) Applicant: Schlumberger Technology Corporation, Sugar Land, TX (US)

(72) Inventors: Yiyan Chen, Sugar Land, TX (US); Z. Frank Zheng, Sugar Land, TX (US)

(21) Appl. No.: 19/228,805

(22) Filed: Jun. 5, 2025

Related U.S. Application Data
(60) Provisional application No. 63/656,200, filed on Jun. 5, 2024.

(51) Int. Cl. B01D 53/14; B01D 53/18; B01D 53/62; B01D 53/75; B01D 53/78; B01D 53/96

(52) U.S. Cl. CPC B01D 53/1406; B01D 53/1425; B01D 53/1475; B01D 53/18; B01D 53/62; B01D 53/75; B01D 53/78; B01D 53/96; B01D 2251/506; B01D 2252/204; B01D 2257/504; B01D 2258/0283

(57) ABSTRACT

A system for removing carbon dioxide from a carbon dioxide-containing gas includes an absorber configured to absorb carbon dioxide from the carbon dioxide-containing gas with a nitrogenous base to form a carbon dioxide-lean gas, an acid wash column configured to remove the nitrogenous base from the carbon dioxide-lean gas with an acid wash solution and form an acid washed solution including the nitrogenous base, and a packed bed including calcium hydroxide configured to deprotonate the nitrogenous base in the acid washed solution. Related systems and methods of removing carbon dioxide from a carbon dioxide-containing gas are also disclosed.

### CROSS REFERENCE TO RELATED APPLICATIONS

This application claims priority from U.S. Provisional Appl. No. 63/656,200 filed on Jun. 5, 2024, which is herein incorporated by reference in its entirety.

### BACKGROUND

Carbon dioxide (CO₂) emissions are a significant contributor to greenhouse gases. For example, byproducts of fossil fuel combustion include CO₂ and other greenhouse gas emissions. During the combustion of fossil fuels, such as in electric power plants for the generation of electricity, flue gas from a furnace, boiler, or engine is emitted through one or more stacks to the atmosphere. The flue gas includes one or more pollutants, such as carbon dioxide, and other pollutants, including sulfur oxides, nitrogen oxides, and particulate matter. The CO₂ is conventionally removed from such materials to reduce greenhouse gas emissions. In addition, carbon dioxide may also be present in natural gas or biogas generated from anaerobic digesters. The CO₂ may be removed from the natural gas or biogas to the increase the concentration of methane in such materials for subsequent use.

Many approaches have been developed to recover CO₂ and other acid gases from post-combustion gases and industrial gases. For example, some methods of capturing CO₂ from a flue gas include the use of an absorber in which the flue gas is absorbed by a liquid absorbent that interacts with the CO₂ in the flue gas to separate the CO₂ from the flue gas and form a CO₂ lean gas having a lower concentration of CO₂ than the flue gas. The absorbent becomes loaded (or enriched; referred to as a “loaded absorbent”) with the CO₂ and the other acid gases that may be present in the flue gas. The CO₂ and other acid gases are subsequently removed from the loaded absorbent to form a CO₂-rich gas. Removal of the CO₂ and other acid gases from the loaded absorbent regenerates the absorbent and forms a lean absorbent having a lower concentration of absorbed CO₂ than the loaded absorbent. The lean absorbent is circulated back to the absorber and the process of absorbing the CO₂ and other acid gases from the flue gas with the absorbent is continued. The CO₂-rich gas may be compressed and utilized in an industrial process and/or injected into a subterranean formation (e.g., depleted hydrocarbon reservoirs in the subterranean formation) for storage.

### BRIEF SUMMARY

In some embodiments, a system for removing carbon dioxide from a carbon dioxide-containing gas includes an absorber configured to absorb carbon dioxide from the carbon dioxide-containing gas with a nitrogenous base to form a carbon dioxide-lean gas, an acid wash column configured to remove the nitrogenous base from the carbon dioxide-lean gas with an acid wash solution and form an acid washed solution including the nitrogenous base, and a packed bed including calcium hydroxide configured to deprotonate the nitrogenous base in the acid washed solution.

Some embodiments include a system for removing carbon dioxide from a carbon dioxide-containing gas including an absorber configured to absorb carbon dioxide from the carbon dioxide-containing gas with a non-aqueous solvent to form a carbon dioxide-lean gas having a lower concentration of carbon dioxide than the carbon dioxide-containing gas, wherein the non-aqueous solvent comprises a nitrogenous base, an acid wash column configured to remove the nitrogenous base entrained in the carbon dioxide-lean gas with sulfuric acid to form an acid washed solution including the sulfuric acid and the nitrogenous base and an acid washed gas having a lower concentration of the nitrogenous base than the carbon dioxide-lean gas, and a packed bed including calcium hydroxide configured to increase a pH of the acid washed solution.

In some embodiments, a method of removing carbon dioxide from a carbon dioxide-containing gas includes absorbing carbon dioxide from the carbon dioxide-containing gas in an absorber with a nitrogenous base to form a loaded absorbent including the carbon dioxide and a carbon dioxide-lean gas including entrained nitrogenous base, removing the nitrogenous base from the carbon dioxide-lean gas with an acid wash solution to form an acid washed solution including the nitrogenous base and a cleaned gas having a lower concentration of the nitrogenous base than the carbon dioxide-lean gas, and passing the acid washed solution through a packed bed including calcium hydroxide to deprotonate the nitrogenous base in the acid washed solution.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a simplified schematic illustrating a carbon capture system, according to at least one embodiment of the disclosure;

FIG. 2 is a simplified schematic illustrating a condenser system including a plurality of condensers arranged in series and configured to reduce a temperature of a CO₂-lean gas, according to at least one embodiment of the disclosure; and

FIG. 3 is a simplified flow diagram illustrating a method of removing carbon dioxide from a CO₂-containing stream, according to at least one embodiment of the disclosure.

### DETAILED DESCRIPTION

This disclosure generally relates to devices, systems, and methods for reducing an amount of an absorbent (e.g., including a nitrogenous base, such as an amine) lost to the atmosphere in carbon capture systems for capturing CO₂ from a CO₂-containing gas (e.g., a flue gas). The carbon capture system may include, for example, an absorber in which the CO₂-containing gas is contacted with an absorbent comprising a non-aqueous solvent (NAS), which may include a nitrogenous base (e.g., an amine) and an organic diluent. The NAS may absorb CO₂ from the CO₂-containing gas and form a CO₂-lean gas and a loaded absorbent that is rich with the CO₂. The carbon capture system further includes a regenerator to remove the CO₂ from the loaded absorbent and form a lean absorbent and a CO₂-rich gas. The lean absorbent may be recycled to the absorber to continuously capture the CO₂ in the CO₂-containing gas. The CO₂-rich gas may be utilized in industrial processes to form carbon-containing materials (e.g., ethanol, sustainable fuels, chemicals, mineral aggregates, and/or other materials) and/or may be stored, such as in a subterranean formation.

In some embodiments, at least some of the nitrogenous becomes entrained in the CO₂-lean gas exiting the absorber. For example, at least some of the nitrogenous base may be vaporized and/or aerosolized in the absorber and carried out of the absorber with the CO₂-lean gas. If the entrained nitrogenous base is not captured in the carbon capture system, the nitrogenous base is lost to the atmosphere. However, the release of the nitrogenous base to the atmosphere may be subject to regulations. For example, the nitrogenous base may form nitrosamines and nitramines, which may be subject to environmental regulations. In addition to environmental concerns, the loss of the nitrogenous base to the atmosphere results in significant losses over the course of operation of the carbon capture system, increasing the operating costs of the carbon capture system.

To reduce the amount of nitrogenous base lost to the atmosphere, the carbon capture system may include a heat exchanger configured to reduce a temperature of the CO₂-lean gas to condense at least a portion (e.g., a first portion) of the nitrogenous base from the CO₂-lean gas and form a cooled CO₂-lean gas. In some embodiments, the heat exchanger includes a condenser configured to reduce a temperature of the CO₂-lean gas to condense at least a first portion of the nitrogenous base in the CO₂-lean gas and separate the condensed first portion of the nitrogenous base from the CO₂-lean gas. In some embodiments, the condenser is between an acid wash column and the absorber and configured to reduce the temperature of the CO₂-lean gas exiting the absorber prior to the CO₂-lean gas entering the acid wash column. The condenser may be configured to reduce the temperature of the CO₂-lean gas using, for example, a refrigeration cycle. In some embodiments, the condenser is configured to reduce the temperature of the CO₂-lean gas to a temperature lower than about 20° C., such as a temperature lower than about 15° C. Responsive to being cooled in the condenser, the first portion of the nitrogenous base may condense out of the CO₂-lean gas. Including the condenser in the carbon capture system facilitates the recovery of the entrained nitrogenous base without the use of a water wash column. In other words, the condenser may facilitate capturing and recovering a first portion of the nitrogenous base from the CO₂-lean gas without the use of a water wash column.

In some embodiments, the condenser facilitates the removal of aerosol particulates that may be present in the CO₂-containing gas. In some embodiments, the cooled CO₂-lean gas is passed through a mist separator configured to facilitate the removal of condensed droplets and/or particles of the nitrogenous base and other condensed materials (e.g., which may be in the form of a mist) from the CO₂-lean gas. For example, the mist separator may be configured to separate the condensed droplets of the first portion of the nitrogenous base from the CO₂-lean gas (e.g., from the cooled CO₂-lean gas gas). The first portion of the nitrogenous base may be returned to the absorber (such as to the top of the absorber), may be returned to a mixing tank including the lean absorbent, or a combination thereof.

In some embodiments, the carbon capture system does not include the condenser. In some such embodiments, the heat exchanger includes a cooler configured to reduce a temperature of a water wash solution provided to a water wash column for treating (e.g., water washing) the CO₂-lean gas to remove a portion (e.g., a first portion) of the nitrogenous base from the CO₂-lean gas and form a water washed gas having a lower concentration of the nitrogenous base than the CO₂-lean gas; and a water washed solution including the portion of the nitrogenous base. The cooler may be configured to reduce the temperature of the water wash solution to a temperature lower than about 20° C. to form a cooled water wash solution. Responsive to being cooled, the cooled water wash solution may contact the CO₂-lean gas in the water wash column, reducing the temperature of the CO₂-lean gas in the water wash column and increasing the removal of the first portion of the nitrogenous base from the CO₂-lean gas in the water wash column.

Accordingly, to improve the capture of the nitrogenous base entrained in the CO₂-lean gas, the carbon capture system may include a heat exchanger (e.g., a condenser, a cooler) configured to reduce a temperature of the CO₂-lean gas and/or reduce a temperature of the water wash solution (which, in turn, reduces the temperature of the CO₂-lean gas when the CO₂-lean gas is contacted by the water wash solution in the water wash column). The heat exchanger may be configured to reduce the temperature of the CO₂-lean gas and/or the water wash solution to a temperature lower than about 20° C.

Condensing the first portion of the nitrogenous base with the condenser or the cooler may reduce the amount of nitrogenous base entrained in the CO₂-lean gas. In addition, the nitrogenous base that is entrained in the CO₂-lean gas may be lean nitrogenous base (not including carbamate species that are absorbed by the nitrogenous base). Accordingly, during or after the condensation of the nitrogenous base, the condensed nitrogenous base may interact with the CO₂ that remains in the CO₂-lean gas and facilitate the further removal of CO₂ from the CO₂-lean gas. Accordingly, in addition to reducing the entrained nitrogenous base in the CO₂-lean gas, condensing the nitrogenous base in the CO₂-lean gas may facilitate the further removal of CO₂ from the CO₂-lean gas, improving the carbon capture efficiency of the carbon capture system.

In addition to the heat exchanger (e.g., the condenser and/or the cooler) and the water wash column (if present), the carbon capture system may include an acid wash column configured to acid wash the nitrogenous base remaining in the water washed gas or the cooled CO₂-lean gas and remove remaining portions of the nitrogenous base from the cooled CO₂-lean gas and/or the water washed gas. The acid wash column may be configured to facilitate contact between an acid (e.g., sulfuric acid) and the cooled CO₂-lean gas and/or the water washed gas to remove substantially all of the nitrogenous base from the cooled CO₂-lean gas and/or the water washed gas and form a clean gas substantially free of CO₂ and the nitrogenous base. An acid washed solution exiting the acid wash column may include the acid and nitrogenous base that is captured from the cooled CO₂-lean gas and/or water washed gas. The nitrogenous base in the acid washed solution may be in the form of a sulfate salt of the nitrogenous base (e.g., an amine sulfate salt).

The nitrogenous base may be phase separated from the acid washed solution to recover the nitrogenous base from the acid washed solution. For example, the acid washed solution may pass through a packed column including calcium hydroxide to increase a pH of the acid washed solution, such as to a pH of at least 12.0 or at least 13.0. Increasing the pH of the acid washed solution may deprotonate the nitrogenous base, facilitating the separation of the nitrogenous base from the aqueous phase of the acid washed solution. In some embodiments, upon interacting with the calcium hydroxide in the packed column, the acid washed solution forms calcium sulfate (as the calcium replaces the nitrogenous base in the sulfate salt to facilitate the deprotonation of the nitrogenous base), which may remain in the acid washed column and is weakly soluble in the aqueous phase of the acid washed solution. For example, since the calcium hydroxide is weakly soluble in the aqueous phase, the calcium hydroxide may precipitate. In some embodiments, the calcium hydroxide precipitates in the packed column rather than downstream of the packed column, where the precipitates could cause issues such as emulsification and fouling of downstream equipment.

A separator may be configured to phase separate the nitrogenous base from the acid washed solution. For example, the deprotonated nitrogenous base may be separated from the acid washed solution using one or more of solvent extraction, distillation, or gravity separation (such as with a cyclone). The separated nitrogenous base may be returned to the absorber, to a mixing tank including the lean absorbent, or to another portion of the carbon capture system including the lean absorbent.

By way of comparison, the use of sodium hydroxide to facilitate separation of the nitrogenous base from the acid washed solution may form sodium sulfate, which is soluble in the aqueous phase and difficult to separate from the acid washed solution. The calcium sulfate, on the other hand, may precipitate out of the acid washed solution, facilitating the separation of the calcium sulfate from the acid washed solution.

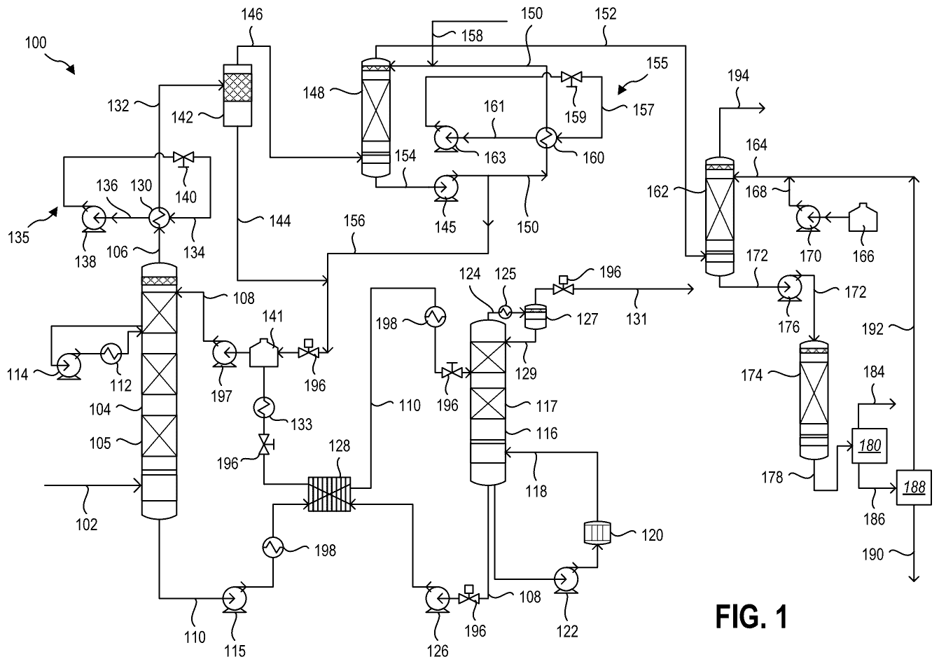

FIG. 1 is a simplified schematic illustrating a carbon capture system 100, according to at least one embodiment of the disclosure. The carbon capture system 100 is configured to remove CO₂ and other acid gases from a carbon dioxide-containing (CO₂-containing) gas 102. The CO₂-containing gas 102 may be a flue gas from a combustion process or another gas from an industrial process. Prior to treatment in the carbon capture system 100, the CO₂-containing gas 102 may be treated by one or more air pollution control devices, such as electrostatic precipitators (ESPs), flue gas desulfurization (FGD) units, selective catalytic NOx reduction (SCR) units, a scrubber, or other emission control devices to reduce the emission of particulates and other materials to the atmosphere. In some embodiments, the CO₂-containing gas 102 includes solid particles in aerosol form carried in the CO₂-containing gas 102. The solid particles may include, for example, dust, fines, or other particulate matter that may be generated by processes that generate the flue gas and not completely removed by air pollution control devices. The solid particles may have a size (e.g., diameter) less than about 10 micrometers (μm). As described herein, the carbon capture system 100 may include a condenser (e.g., condenser 130) and/or a cooler (e.g., cooler 160) configured to facilitate agglomeration and removal of the particulate matter from a CO₂-lean gas 106. Accordingly, the carbon capture system 100 described herein may reduce the emission of such particulate matter such as dust, fines, as well as the emission of droplets or aerosols.

The CO₂-containing gas 102 may be provided to an absorber 104 where the CO₂ in the CO₂-containing gas 102 may be at least partially (e.g., substantially) removed from the CO₂-containing gas 102 to form a carbon dioxide-lean (CO₂-lean) gas 106 having a lower concentration of CO₂ than the CO₂-containing gas 102. A temperature of the CO₂-containing gas 102 may be within a range of from about 40° C. to about 120° C., such as from about 40° C. to about 60° C., from about 60° C. to about 90° C., or from about 90° C. to about 120° C. The temperature of the CO₂-containing gas 102 may be controlled by, for example, passing the CO₂-containing gas 102 through a heat exchanger (not shown) prior to introducing the CO₂-containing gas 102 to the absorber 104. In some embodiments, the temperature of the CO₂-containing gas 102 after exiting the heat exchanger and prior to entering the absorber 104 is within a range of from about 25° C. to about 40° C. In some embodiments, the absorber 104 may be configured to remove from about 85 percent to about 95 percent of the CO₂ from the CO₂-containing gas 102. In some such embodiments, from about 5 percent to about 15 percent of the CO₂ originally present in the CO₂-containing gas 102 remains in the CO₂-lean gas 106. However, depending on the operating conditions of the absorber 104, the efficiency of CO₂ removal from the CO₂-containing gas 102 may be as high as or higher than about 99 percent or even higher. As described herein, the carbon capture system 100 may include condenser 130 and/or a cooler 160 configured to facilitate improved capture of the CO₂ from the CO₂-containing gas 102.

The CO₂-containing gas 102 may be provided to a lower portion of the absorber 104 and flow countercurrent to an absorbent (e.g., a lean absorbent 108) provided to an upper portion of the absorber 104. The lean absorbent 108 may flow downwardly (e.g., such as by gravity) through the absorber 104 countercurrent to the CO₂-containing gas 102. The lean absorbent 108 absorbs CO₂ from the CO₂-containing gas 102 to remove CO₂ from the CO₂-containing gas 102 and form the CO₂-lean gas 106. Absorption of the CO₂ from the CO₂-containing gas 102 loads the lean absorbent 108 with CO₂ and forms a loaded absorbent 110 (also referred to as a “CO₂-rich absorbent,” a “loaded solvent,” a “CO₂-rich solvent,” or “a CO₂-loaded solvent”), which exits at a bottom of the absorber 104.

The lean absorbent 108 and the loaded absorbent 110 may each include substantially the same material composition, except that the lean absorbent 108 may include less CO₂ absorbed therein than the loaded absorbent 110. In some embodiments, the lean absorbent 108 and the loaded absorbent 110 include a NAS. Reference to the absorbent herein refers to the NAS. The NAS may include an organic solvent system that may be partially miscible with water or immiscible with water. The NAS may include polar aprotic solvent systems, protic solvent systems, and mixtures thereof. In some embodiments, the NAS includes a nitrogenous base (e.g., an amine, such as an organic amine) and an organic diluent. In some embodiments, the NAS further includes water.

The nitrogenous base of the NAS may include an amine (e.g., a primary amine, a secondary amine), an amidine, a guanidine (e.g., 1,1,3,3-tetramethylguanidine (“TMG”)), a triazole (e.g., 1,2,3-triazole, 1,2,4-triazole), or combinations thereof. In some embodiments, the nitrogenous base includes a hydrophobic amine. The amine may include one or more of N-methylbenzylamine (NMBA), 2-fluoro-N-methylbenzylamine, 3-fluoro-N-methylbenzylamine, 4-fluoro-N-methylbenzylamine, 3,5-difluorobenzylamine, 1,4-diazabicyclo-undec-7-ene (“DBU”), 1,4-diazabicyclo-2,2,2-octane, piperazine (“PZ”), triethylamine (“TEA”), 1,8-diazabicycloundec-7-ene, monoethanolamine (“MBA”), diethyl amine (“DEA”), ethylenediamine (“EDA”), methyldiethanolamine (MDEA), 2-amino 1-propanol (AMP), 1,3-diamino propane, 1,4-diaminobutane, hexamethylenediamine, 1,7-diaminoheptane, diethanolamine, diisopropylamine (“DIPA”), 4-aminopyridine, pentylamine, hexylamine, heptylamine, octylamine, nonyl amine, decylamine, tert-octylamine, dioctylamine, dihexylamine, 2-ethyl-1-hexylamine, 2-fluorophenethylamine, 3-fluorophenethylamine, 4-fluorophenethylamine, D-4-fluoro-alpha-methylbenzylamine, L-4-fluoro-alpha-methylbenzylamine, imidazole, benzimidazole, N-methyl imidazole, 1-trifluoroacetylimidazole, or combinations thereof. In some embodiments, the hydrophobic amine includes N-methylbenzylamine.

The organic diluent may include a polyether diluent and may be selected from the group consisting of alcohols, ketones, aliphatic hydrocarbons, aromatic hydrocarbons, nitrogen heterocycles, oxygen heterocycles, aliphatic ethers, cyclic ethers, esters, and amides and mixtures thereof. In some embodiments, the organic diluent includes a polyether diluent, such as a polyethylene glycol dialkyl ether. By way of non-limiting example, the organic diluent may include a polyglycol dimethyl ether, a polyglycol dibutyl ether, or a combination thereof. In some embodiments, the organic diluent includes diethylene glycol dibutyl ether, triethylene glycol dibutyl ether, tetraethylene glycol dibutyl ether, or combinations thereof. In some embodiments, the organic diluent includes triethylene glycol dibutyl ether. In some embodiments, the organic diluent includes a polyethylene glycol dialkyl ether, such as Genosorb® 1843, commercially available from Clariant of Muttenz, Switzerland. The organic diluent may be formulated and configured to remove at least some of the acid gases (e.g., CO₂) in the CO₂-containing gas 102 by directly contacting the CO₂-containing gas 102.

In some embodiments, the nitrogenous base includes NMBA and the organic diluent includes one or more polyethylene glycol dialkyl ethers. In some such embodiments, the NAS includes NMBA and one or more polyethylene glycol dialkyl ethers, such as one or more of diethylene glycol dibutyl ether, triethylene glycol dibutyl ether, or tetraethylene glycol dibutyl ether.

The NAS may include a mixture of the nitrogenous base, the organic diluent, and water. The NAS may include substantially equal proportions by molarity of the nitrogenous base and the organic diluent. In some such embodiments, the nitrogenous base and the organic diluent are present in the NAS in equimolar amounts.

In some embodiments, the NAS includes a greater weight percent of the nitrogenous base than of the organic diluent. The nitrogenous base may constitute from about 40.0 weight percent to about 70 weight percent of the NAS, such as from about 40.0 weight percent to about 50.0 weight percent, from about 50.0 weight percent to about 60.0 weight percent, or from about 60.0 weight percent to about 70.0 weight percent of the NAS. In some embodiments, the nitrogenous base constitutes from about 50.0 weight percent to about 60.0 weight percent, such as about 55.0 weight percent of the NAS.

The organic diluent may constitute from about 30.0 weight percent to about 50.0 weight percent of the NAS, such as from about 30.0 weight percent to about 35.0 weight percent, from about 35.0 weight percent to about 40.0 weight percent, from about 40.0 weight percent to about 45.0 weight percent, or from about 45.0 weight percent to about 50.0 weight percent of the NAS. In some embodiments, the organic diluent constitutes from about 35.0 weight percent to about 40.0 weight percent, such as about 37.0 weight percent of the NAS.

Water may constitute from about 2.5 weight percent to about 12.5 weight percent of the NAS, such as from about 2.5 weight percent to about 3.0 weight percent, from about 3.0 weight percent to about 4.0 weight percent, from about 4.0 weight percent to about 5.0 weight percent, from about 5.0 weight percent to about 6.0 weight percent, from about 6.0 weight percent to about 7.0 weight percent, from about 7.0 weight percent to about 8.0 weight percent, from about 8.0 weight percent to about 9.0 weight percent, from about 9.0 weight percent to about 10.0 weight percent, from about 10.0 weight percent to about 11.0 weight percent, or from about 11.0 weight percent to about 12.5 weight percent of the NAS. In some embodiments, water constitutes from about 7.0 weight percent to about 8.0 weight percent of the NAS. However, the disclosure is not so limited, and the weight percent of the water in the NAS may be different than that described. In some embodiments, the NAS includes about 55 weight percent of the nitrogenous base, about 37 weight percent of the organic diluent, and about 8 weight percent of water.

The NAS may have a density within a range of from about 0.90 g/cm³ to about 0.98 g/cm³, such as from about 0.90 g/cm³ to about 0.92 g/cm³, from about 0.92 g/cm³ to about 0.94 g/cm³, from about 0.94 g/cm³ to about 0.96 g/cm³, or from about 0.96 g/cm³ to about 0.98 g/cm³. In some embodiments, the density of the NAS is about 0.94 g/cm³.

The absorber 104 may be configured to provide sufficient contact between the CO₂-containing gas 102 and the lean absorbent 108 to facilitate absorption of CO₂ and other acid gases present in the CO₂-containing gas 102 by the lean absorbent 108 to form the CO₂-lean gas 106. Contacting the lean absorbent 108 with the CO₂-containing gas loads the lean absorbent 108 with the CO₂ to form the loaded absorbent 110. The absorber 104 may include one or more sections of packed beds 105 including one or more packing materials. The packing materials may include, for example, stainless steel, structured packing materials, Pall rings, rings of steel or aluminum, other packing materials, or combinations thereof. In some embodiments, the absorber 104 includes trays (e.g., sieve trays, valve trays) through which the lean absorbent 108 falls via gravity as the gas passes upwardly through the trays while contacting the lean absorbent 108.

The absorber 104 may further include or be operably coupled to one or more interstage coolers 112 configured to cool the NAS as the NAS flows downwardly through the absorber 104. Cooling the NAS may increase the CO₂ capacity of the NAS and facilitate improved capture of CO₂ from the CO₂-containing gas 102 by the NAS. The interstage coolers 112 may cool the NAS using water, for example. The NAS may be provided to the interstage coolers 112 by means of a pump 114. While the absorber 104 has been described as including two section of packed beds 105 and one interstage cooler 112, the disclosure is not so limited, and the absorber 104 may include a different (e.g., a greater) number of packed beds 105 and interstage coolers 112 and associated pumps 114.

With reference to FIG. 1, the loaded absorbent 110 may be provided to a regenerator 116 (also referred to as a “regenerator column”) via a pump 115. The regenerator 116 is configured to remove the CO₂ and other acid gases from the loaded absorbent 110 and form the lean absorbent 108 that is provided to (e.g., recycled to, circulated to) the absorber 104. Thus, the regenerator 116 facilitates removal of CO₂ and other acid gases from the loaded absorbent 110 to form the lean absorbent 108. Accordingly, the NAS may be circulated through the carbon capture system 100 to capture CO₂ in the absorber 104, followed by release of the absorbed CO₂ in the regenerator 116 and recycling of the NAS to the absorber 104 to continue the process of capturing the CO₂ from the CO₂-containing gas 102.

The loaded absorbent 110 may be provided to an upper section of the regenerator 116 and flow downwardly in the regenerator 116. A stream 118 including water vapor and CO₂ may be provided to a lower portion of the regenerator 116 and flow upwardly through the regenerator 116 to contact the downwardly flowing loaded absorbent 110 and remove the CO₂ and other acid gases from the loaded absorbent 110 to form the lean absorbent 108. Thus, the stream 118 may flow countercurrent to the loaded absorbent 110 in the regenerator 116. A portion of the lean absorbent 108 exiting the bottom of the regenerator 116 may be provided to a reboiler 120 by means of a pump 122. The reboiler 120 heats the portion of the lean absorbent 108 to generate the stream 118 provided to the regenerator 116. The stream 118 may further include volatilized NAS. In some embodiments, the reboiler 120 heats the lean absorbent 108 to a temperature within a range of from about 110° C. to about 130° C.

As described above with reference to the absorber 104, the regenerator 116 may include one or more sections of packed beds 117 including one or more packing materials such as, for example, stainless steel, structured packing materials, Pall rings, rings of steel or aluminum, other packing materials, or combinations thereof. In some embodiments, the regenerator 116 includes trays (e.g., sieve trays, valve trays) through which the absorbent falls via gravity as the stream 118 passes upwardly through the trays while contacting the CO₂-rich absorbent 110. While FIG. 1 illustrates that the regenerator 116 includes two sections of packed beds 117, the disclosure is not so limited. In other embodiments, the regenerator 116 includes a single section of a packed bed 117 or includes more than two sections of packed beds 117.

With continued reference to FIG. 1, regenerating the NAS in the regenerator 116 releases the CO₂ from the loaded absorbent 110 and forms a CO₂-rich gas 124 that exits the top of the regenerator 116. In some embodiments, vapors entrained in the CO₂-rich gas 124 are condensed in a cooler 125 and collected in vessel (e.g., a decanter) 127. A reflux 129 including a liquid comprising the condensed vapors may be recycled to the regenerator 116. In some embodiments, the reflux 129 includes water. Vapors from the vessel 127 include a CO₂ product 131 from which water and other liquids have been removed.

The CO₂ product 131 may be further processed to remove any impurities (e.g., absorbent, steam) therefrom. The CO₂ product 131 may be stored in an earth formation (e.g., sequestered), may be used in the manufacture of other materials (e.g., ethanol, sustainable aviation fuel, chemicals, mineral aggregates, and/or other materials), or combinations thereof.

After leaving the bottom of the regenerator 116, the lean absorbent 108 may be provided to the absorber 104. In some embodiments, a pump 126 pumps the lean absorbent 108 to a heat exchanger 128 configured to heat the loaded absorbent 110 from the bottom of the absorber 104 with the lean absorbent 108 from the bottom of the regenerator 116 and cool the lean absorbent 108 entering the absorber 104. In some embodiments, the lean absorbent 108 may be further cooled in a cooler 133 to lower a temperature of the lean absorbent 108 and increase a CO₂ capacity of the lean absorbent 108 in the absorber 104. In some embodiments, the cooler 133 is substantially the same as the interstage cooler 112.

In some embodiments, at least some of the NAS from the lean absorbent 108 may be entrained in the CO₂-lean gas 106 exiting the absorber 104. A temperature of the CO₂-lean gas 106 may be within a range of from about 30° C. to about 70° C., such as from about 30° C. to about 40° C., from about 40° C. to about 50° C., from about 50° C. to about 60° C., or from about 60° C. to about 70° C. Depending, at least in part, on the temperature and the pressure of each of the absorber 104 and the CO₂-lean gas 106, the CO₂-lean gas 106 exiting the absorber 104 may include at least some entrained nitrogenous base. For example, at least a portion of the nitrogenous base may be vaporized and/or aerosolized and exit the absorber 104 with the CO₂-lean gas 106. The concentration of the nitrogenous base entrained in the CO₂-lean gas 106 may depend on the composition of the nitrogenous base, the temperature of the CO₂-lean gas 106, and the pressure of the CO₂-lean gas 106. By way of non-limiting example, in some embodiments, the CO₂-lean gas 106 may include from about 20 ppm to about 3,000 ppm of the nitrogenous base (e.g., the amine), such as from about 300 ppm to about 600 ppm of the nitrogenous base. In some embodiments, the CO₂-lean gas 106 includes more than about 100 ppm, such as more than about 200 ppm, more than about 300 ppm, more than about 500 ppm, or more than about 1,000 ppm of the nitrogenous base. The CO₂-lean gas 106 may not include any or a significant amount of the organic diluent since the organic diluent may exhibit a vapor pressure lower than a vapor pressure of the nitrogenous base.

In some embodiments, the carbon capture system 100 includes a heat exchanger configured to reduce a temperature of the CO₂-lean gas 106 and facilitate condensation and removal of the nitrogenous base from the CO₂-lean gas 106. Reducing the temperature of the CO₂-lean gas 106 may reduce the vapor pressure of the entrained nitrogenous base, facilitating the condensation of the nitrogenous base from the CO₂-lean gas 106.

In some embodiments, the heat exchanger includes a condenser 130 formulated and configured to reduce the temperature of the CO₂-lean gas 106 and form a cooled CO₂-lean gas 132 having a lower temperature than the CO₂-lean gas 106. The condenser 130 may be configured to receive the CO₂-lean gas 106 from the absorber 104 and reduce the temperature of the CO₂-lean gas 106 to form the cooled CO₂-lean gas 132. In some embodiments, the condenser 130 is located between the absorber 104 and a water wash column 148 configured to remove a portion of the nitrogenous base from the CO₂-lean gas 106.

The condenser 130 may be configured to reduce the temperature of the CO₂-lean gas 106 to form the cooled CO₂-lean gas 132 having temperature lower than about 20° C., such as a temperature lower than about 15° C., or a temperature lower than about 10° C. In some embodiments, the condenser 130 is configured to reduce the temperature of the CO₂-lean gas 106 to a temperature within a range of from about 10° C. to about 20° C. The condenser 130 may be configured to reduce the temperature of the CO₂-lean gas 106 to a temperature lower than about 20° C., but greater than about 0° C. to reduce or prevent freezing of any water vapor present in the CO₂-lean gas 106.

The amount that the condenser 130 reduces the temperature of the CO₂-lean gas 106 may depend, at least in part, on one or more of the temperature of the CO₂-containing gas 102, the temperature of the lean absorbent 108, and the size of the condenser 130. The condenser 130 may be configured to reduce the temperature of the CO₂-lean gas 106 such that a temperature difference between the CO₂-lean gas 106 and the cooled CO₂-lean gas 132 is within a range of from about 10° C. to about 60° C., such as from about 10° C. to about 20° C., from about 20° C. to about 30° C., from about 30° C. to about 40° C., from about 40° C. to about 50° C., or from about 50° C. to about 60° C. However, the disclosure is not so limited, and the condenser 130 may be configured to reduce the temperature of the CO₂-containing gas 102 by a different amount than that described.

Reducing the temperature of the CO₂-lean gas 106 may reduce a partial pressure (and the corresponding concentration) of the entrained nitrogenous base in the CO₂-lean gas 106. As one example, Table 1 below shows how the temperature of the CO₂-lean gas 106 affects the vapor pressure and the concentration of the nitrogenous base.

TABLE 1

| Temperature | Vapor | Nitrogenous base |
|---|---|---|
| (° C.) | pressure (Pa) | concentration (ppm) |
| 10 | 12 | 19 |
| 20 | 27 | 40 |
| 30 | 56 | 80 |
| 40 | 111 | 153 |
| 50 | 211 | 282 |
| 60 | 387 | 500 |
| 70 | 683 | 858 |
| 80 | 1169 | 1426 |

A portion (e.g., a first portion) of the entrained nitrogenous base may be condensed in the cooled CO₂-lean gas 132. For example, reducing the temperature of the CO₂-lean gas 106 may induce the formation of droplets of the nitrogenous base. The size of the droplets may depend, at least in part, on the temperature and/or the pressure of the cooled CO₂-lean gas 132. The droplets of the nitrogenous base may condense on particles of the particulate material (e.g., dust, fines) that may be present in the cooled CO₂-lean gas 132 to form larger droplets including the particulate material. In some embodiments, the particulate material acts as a nucleus or seed on which the droplets condense. After the droplets reach a size such that they are no longer carried by the cooled CO₂-lean gas 132, the agglomerations of the droplets fall out of the cooled CO₂-lean gas 132 to separate from the CO₂ in the CO₂-lean gas 132.

The condenser 130 may be configured to reduce the temperature of the CO₂-lean gas 106 with a heat transfer medium, such as a refrigerant. A cool heat transfer medium 134 having a temperature lower than a temperature of the CO₂-lean gas 106 may be provided to the condenser 130 where the cool heat transfer medium 134 exchanges heat with the CO₂-lean gas 106 and cools the CO₂-lean gas 106 to form the cooled CO₂-lean gas 132 and a heated heat transfer medium 136.

The heat transfer medium may include, for example, one or more of ammonia (NH₃), ethylene glycol, difluoromethane (CH₂F₂), pentafluoroethane (CHF₂CF₃), chlorodifluoromethane (CHClF₂), 1,1,1-trifluoroethane (C₂H₃F₃), 1,1,1,2-tetrafluoroethane (C₂H₂F₄), 1,1,2,2-tetrafluoroethane (C₂H₂F₄), chilled water, another refrigerant, or combinations thereof. However, the disclosure is not limited to the particular refrigerants of the heat transfer medium, and the heat transfer medium may include other refrigerants.

The condenser 130 may include any type of heat exchanger configured to facilitate the transfer of thermal energy between the CO₂-lean gas 106 and the cool heat transfer medium 134 to condense at least a portion of the nitrogenous base in the CO₂-lean gas 106. By way of non-limiting example, the condenser 130 may include a surface condenser, an evaporator, a plate and frame heat exchanger, or another type of heat exchanger. However, the disclosure is not limited to the particular type of condenser 130. In some embodiments, the condenser 130 is part of a refrigeration loop 135 wherein the heated heat transfer medium 136 is passed through a compressor 138 configured to increase a pressure of the heated heat transfer medium 136, which is them passed through an expansion valve 140 to induce a pressure drop across the expansion valve 140 and a corresponding reduction in temperature of the heated heat transfer medium 136 to form the cool heat transfer medium 134.

In some embodiments, the carbon capture system 100 includes a mist separator 142 configured to receive the cooled CO₂-lean gas 132 and remove the first portion of the nitrogenous base and condensed particulate matter (e.g., dust, fines, other particulate materials) present in the cooled CO₂-lean gas 132. The mist separator 142 may be configured to facilitate separation of liquids in the cooled CO₂-lean gas 132 to form a condensate 144 including the first portion of the nitrogenous base and a demisted CO₂-lean gas 146 including a lower concentration of the nitrogenous base than the CO₂-lean gas 106 and/or the cooled CO₂-lean gas 106. The mist separator 142 may also be referred to as a demister or mist eliminator.

The mist separator 142 may include one or more of a gravity separator, a centrifugal separator, a filter vane separator including mist eliminator pads, and a liquid/gas coalescer. The type of the mist separator 142 may depend, at least in part, on the size of the condensed droplets of the first portion of the nitrogenous base. In some embodiments, the mist separator 142 includes a mist eliminator, a filter vane separator, or a liquid/gas coalescer.

With continued reference to FIG. 1, the condensate 144 including the first portion of the nitrogenous base may be returned to the absorber 104, such as to the top of the absorber 104. In other embodiments, the condensate 144 is provided to a mixing tank 141 where the lean absorbent 108 from the regenerator 116 is mixed with the condensate 144.

While FIG. 1 illustrates that the carbon capture system 100 includes the mist separator 142, the disclosure is not so limited. In some embodiments, the condensed nitrogenous base is removed from the cooled CO₂-lean gas 132 in the condenser 130.

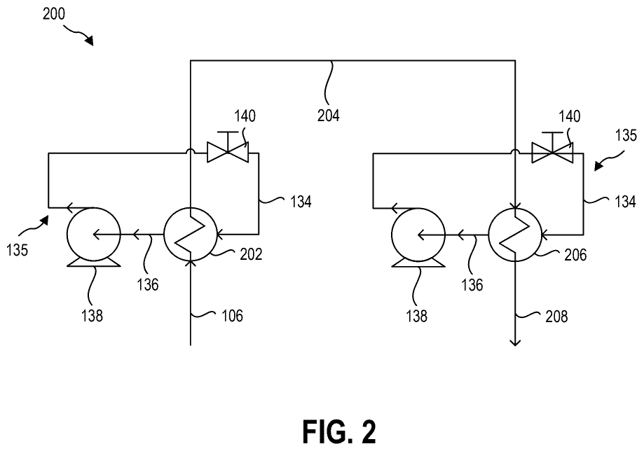

While the carbon capture system 100 has been described and illustrated as including a single condenser 130, the disclosure is not so limited. In other embodiments, the carbon capture system 100 includes a plurality of condensers configured to reduce the temperature of the CO₂-lean gas 106. FIG. 2 is a simplified schematic illustrating a condenser system 200 including a plurality of condensers arranged in series and configured to reduce a temperature of a CO₂-lean gas 106, according to at least one embodiment of the disclosure.

With reference to FIG. 2, the CO₂-lean gas 106 may be provided to a first condenser 202 to form a first cooled CO₂-lean gas 204 having a lower temperature than the CO₂-lean gas 106. The first condenser 202 may be substantially the same as the condenser 130 described above with reference to FIG. 1. The first condenser 202 may be configured to reduce the temperature of the CO₂-lean gas 106 using a refrigeration loop, such as the refrigeration loop 135 described with reference to FIG. 1. The first cooled CO₂-lean gas 204 may be provided to a second condenser 206 configured to reduce the temperature of the first cooled CO₂-lean gas 204 to form a second cooled CO₂-lean gas 208 having a lower temperature than the first cooled CO₂-lean gas 204. The second condenser 206 may be substantially similar to the condenser 130 and may be configured to further cool the first cooled CO₂-lean gas 204 using a refrigeration loop 135. In some embodiments, the second cooled CO₂-lean gas 208 is provided to the mist separator 142 (FIG. 1). In other embodiments, the second cooled CO₂-lean gas 208 is further cooled using one or more additional condensers.

In other embodiments, the condenser system 200 includes a mist separator substantially similar to (e.g., the same as) the mist separator 142 (FIG. 1) after each condenser. In some such embodiments, a quantity of the mist separators in the condenser system 200 may be the same as a quantity of the condensers in the condenser system 200.

While the carbon capture system 100 has been described as including the condenser 130 and the mist separator 142 for reducing a temperature of the CO₂-lean gas 106 and condensing the nitrogenous base from the CO₂-lean gas 106, the disclosure is not so limited. In other embodiments, the temperature of the CO₂-lean gas 106 may be reduced by reducing a temperature of a water wash solution 150 using a cooler 160. The carbon capture system 100 may include the cooler 160 in addition to, or instead of, the condenser 130 and the mist separator 142.

In some embodiments, the carbon capture system 100 includes a water wash section configured to facilitate recovery of the nitrogenous base from the CO₂-lean gas 106 (or from the demisted CO₂-lean gas 146 that is not removed in the first portion of the nitrogenous base by the condenser 130 and the mist separator 142). The water wash section may include a water wash column 148 configured to remove a portion (e.g., a first portion) of the nitrogenous base from the CO₂-lean gas 106. For example, in some embodiments, the carbon capture system 100 does not include the condenser 130 or the mist separator 142 for removing the first portion of the nitrogenous base from the CO₂-lean gas 106. Rather, the carbon capture system 100 includes the water wash column 148 for removing the first portion of the nitrogenous base from the CO₂-lean gas 106 using a cooled water wash solution 150.

A water wash solution 150 may be provided to the water wash column 148 and flow downwardly and countercurrent to the upwardly flowing CO₂-lean gas 106. The water wash solution 150 may include water. The water wash solution 150 may contact the CO₂-lean gas 106 in the water wash column 148 and capture a first portion of the entrained nitrogenous base from the CO₂-lean gas 106. A water washed gas 152 having a lower concentration of the nitrogenous base than the may exit the top of the water wash column 148, and a water washed solution 154 including some of the captured nitrogenous base (the first portion of the nitrogenous base) may exit the bottom of the water wash column 148. The water washed solution 154 may include the solution of the water wash solution 150 (e.g., water) and the nitrogenous base (e.g., the second portion of the nitrogenous base) that is captured by the water wash solution 150. The concentration of the nitrogenous base in the water washed gas 152 may be lower than the concentration of the nitrogenous base in the demisted CO₂-lean gas 106. In some embodiments, a concentration of the nitrogenous base in the water washed gas 152 is within a range of from about 30 ppm to about 100 ppm, such as from about 30 ppm to about 40 ppm, from about 40 ppm to about 6 ppm, or from about 60 ppm to about 100 ppm. In some embodiments, the concentration of the nitrogenous base in the water washed gas 152 is greater than about 30 ppm.

The water wash column 148 may include a packed bed to facilitate increased contact between the CO₂-lean gas 106 and the water wash solution 150. The packed bed may include one or more packing materials, such as one or more of stainless steel, structured packing materials, Pall rings, rings of steel or aluminum, other packing materials, or combinations thereof.

While FIG. 1 illustrates that the carbon capture system 100 includes a single water wash column 148, the disclosure is not so limited. In other embodiments, the carbon capture system 100 includes more than one water wash column 148, which may be arranged in series with respect to each other.

A water wash return 156 including a portion of the water washed solution 154 may be returned to the absorber 104. In some embodiments, the water wash return 156 is provided to a mixing tank 141 (or a mixer) where the water wash return 156 is mixed with the lean absorbent 108 from the regenerator 116 prior to returning to the absorber 104. Another portion of the water washed solution 154 may be returned to the water wash column 148 as the water wash solution 150. In some embodiments, make-up water 158 may be added to the water wash solution 150. The water washed solution 154 and make-up water 158 may be pumped with a water wash pump 145.

The cooler 160 may be configured to reduce a temperature of a water wash solution 150 which, in turn, reduces the temperature of the CO₂-lean gas 106 as the CO₂-lean gas 106 passes through the water wash column 148. Cooling the water wash solution 150 in the cooler 160 may facilitate improved recovery of nitrogenous base from the CO₂-lean gas 106, such as by improving condensation of the nitrogenous base in the water wash column 148. The CO₂-lean gas 106 may be received by the water wash column 148 and the water wash solution 150 may facilitate removal of a first portion of the nitrogenous base from the CO₂-lean gas 106.

The cooler 160 may be configured to reduce a temperature of the water wash solution 150 to a temperature lower than about 20° C., such as within a range of from about 10° C. to about 20° C. The cooler 160 may be configured to reduce the temperature of the water wash solution 150 to a temperature less than about 20° C., such as less than about 15° C., or even less than about 10° C. The cooler 160 may be configured to maintain a temperature of the water wash solution 150 above a freezing temperature (e.g., above about 0° C.).

In some embodiments, the cooler 160 may be part of a refrigeration loop 155 similar to the refrigeration loop 135. The cooler 160 may be configured to reduce the temperature of the water wash solution 150 with a cold heat transfer medium 157. For example, the refrigeration loop 155 may include an expansion valve 159 configured to induce a pressure drop of a heated heat transfer medium 161 and generate the cold heat transfer medium 157; and a compressor 163 configured to increase a pressure of the heated heat transfer medium 161 generate the cold heat transfer medium 157 having a lower temperature than the heat transfer medium 161.

In some embodiments, the cooler 160 is substantially similar to the condenser 130 described above (except that the cooler 160 may not induce a phase change, since the cooler 160 cools the water wash solution 150 rather than directly cooling the CO₂-lean gas 106). The cold heat transfer medium 157 and the heated heat transfer medium 161 may include the same materials described above with reference to the heat transfer medium of the heated heat transfer medium 136 and the cool heat transfer medium 134.

Accordingly, the carbon capture system 100 may include one or both of the condenser 130 and the cooler 160 to reduce a temperature of the CO₂-lean gas 106 and increase an amount of the nitrogenous base removed from the CO₂-lean gas 106. In embodiments including the condenser 130, the condenser 130 and the mist separator 142 facilitate the removal of a first portion of the nitrogenous base from the CO₂-lean gas 106. In embodiments not including the condenser 130 and including the cooler 160, the water wash column 148 facilitates the removal of a first portion of the nitrogenous base from the CO₂-lean gas 106. Without being bound by any particular theory, it is believed that by lowering the temperature of the CO₂-lean gas 106 (using either the condenser 130 to directly condense the nitrogenous base from the CO₂-lean gas 106, or the cooler 160 to reduce the temperature of the water wash solution 150), the vapor pressure of the nitrogenous base in the CO₂-lean gas 106 is reduced. According to the Antione equation, the concentration of the nitrogenous base is reduced by lowering the temperature of the CO₂-lean gas 106 and the corresponding vapor pressure of the nitrogenous base in the CO₂-lean gas 106.

The water washed gas 152 may include a lower concentration of the nitrogenous base than the CO₂-lean gas 106 and/or the demisted CO₂-lean gas 146. With continued reference to FIG. 1, the carbon capture system 100 may include an acid wash column 162 configured to remove the nitrogenous base from the demisted CO₂-lean gas 146 (in embodiments including the condenser 130) or from the water washed gas 152 (in embodiments including the water wash column 148 and the cooler 160) and form a cleaned gas 194 (also referred to as a “treated gas” or an “acid washed gas”) substantially free of the nitrogenous base. The cleaned gas 194 may have a lower concentration of CO₂ than the CO₂-containing gas 102 and may be released (vented) to the atmosphere. The cleaned gas 194 may include substantially the same composition as the water washed gas 152, except that the cleaned gas 194 may include a lower concentration of the nitrogenous base than the water washed gas 152.

The acid wash column 162 may be configured to facilitate contact between an acid wash solution and the demisted CO₂-lean gas 146 from the mist separator 142 or the water washed gas 152 from the water wash column 148. The demisted CO₂-lean gas 146 or the water washed gas 152 may flow countercurrent to the acid wash solution 164 in the acid wash column 162. The acid wash solution 164 may be provided to an upper portion of the acid wash column 162 and flow downwardly and countercurrent to the upwardly flowing demisted CO₂-lean gas 146 or water washed gas 152. In some embodiments, the carbon capture system 100 includes an acid tank 166 configured to provide make-up acid 168 to the acid wash column 162 via a pump 170.

The acid wash column 162 may include one or more packing materials to facilitate contact between the acid wash solution 164 and the nitrogenous base (present in the demisted CO₂-lean gas 146 or the water washed gas 152), as described above with reference to the water wash column 148. As the acid wash solution 164 contacts the nitrogenous base in the acid wash column 162, the acid wash solution 164 neutralizes (e.g., protonates, forms an amine salt from) the nitrogenous base in the demisted CO₂-lean gas 146 or the water washed gas 152 to form an acid washed solution 172 including the acid of the acid wash solution 164 and neutralized nitrogenous base (e.g., neutralized amine). As used herein, neutralization of the nitrogenous base means and includes formation of a salt of the nitrogenous base, wherein the nitrogenous base is protonated. For example, a neutralized nitrogenous base may include a protonated nitrogenous base and a counter anion. Neutralization of the nitrogenous base may remove the nitrogenous base from the demisted CO₂-lean gas 146 or the water washed gas 152 and form the cleaned gas 194 substantially free of the nitrogenous base. Neutralization of the nitrogenous base may increase the solubility of the nitrogenous base in the aqueous phase and, therefore, in the acid wash solution 164, facilitating removal of the nitrogenous base from the demisted CO₂-lean gas 146 or the water washed gas 152. In some embodiments, the neutralized nitrogenous base is soluble in the acid washed solution 172. The acid washed solution 172 may include a multicomponent solution including the acid of the acid wash solution 164 and the neutralized nitrogenous base, which may be in the form of an amine salt. In embodiments where the acid wash solution 164 includes sulfuric acid, the amine salt may include an amine sulfate salt.

The acid wash solution 164 may include a strong acid, such as sulfuric acid. A concentration of the acid in the acid wash solution 164 may selected such that the pH of the acid wash solution 164 is within a range of from about 2.5 to about 3.5, such as from about 2.5 to about 3.0, or from about 30.0 to about 3.5. In use and operation, as the acid wash solution 164 contacts the nitrogenous base in the demisted CO₂-lean gas 146 or the water washed gas 152, the pH of the acid wash solution 164 increases. Additional acid may be added to the acid wash solution 164 to maintain a pH of the acid wash solution 164 of about 3.0. However, the disclosure is not so limited and the acid of the acid wash solution 164 may include one or more different acids and the concentration of the acid in the acid wash solution 164 may be different than that described.

As described above, the acid wash solution 164 neutralizes (e.g., protonates) the nitrogenous base in the demisted CO₂-lean gas 146 or the water washed gas 152 and forms the acid washed solution 172 to include the acid of the acid wash solution 164 and the neutralized nitrogenous base. To recover the nitrogenous base from the acid washed solution 172, the neutralized nitrogenous base may be protonated, such as with a strong base. Protonation of the nitrogenous base may free the nitrogenous base from the amine salt, which may facilitate separation of the nitrogenous base from the aqueous phase of the acid washed solution 172.

In some embodiments, the acid washed solution 172 is provided to a packed column 174 (also referred to as a “packed bed”) including a base (via a pump 176). In some embodiments, the acid washed solution 172 is pumped to the packed column 174. The packed column 174 may be packed with solid pellets and/or solid grains of a base material, such as of a strong base. In some embodiments, the base material includes calcium hydroxide (Ca(OH)₂) and the packed column 174 includes a calcium hydroxide packed column (also referred to as a “lime packed column”).

In some embodiments, the packed column 174 may be configured to increase a pH of the acid washed solution 172 to form a base treated acid washed solution 178 having a higher pH than the acid washed solution 172 entering the packed column 174. For example, responsive to passing through the packed column 174, the pH of the base treated acid washed solution 178 may increase to at least about 12.0, such as at least about 12.5, or at least about 13.0. The relatively higher pH of the base treated acid washed solution 178 may facilitate improved separation of the nitrogenous base from the base treated acid washed solution 178.

Responsive to contacting the base material (e.g., the calcium hydroxide) in the packed column 174, the protonated nitrogenous base in the acid washed solution 172 may be deprotonated. Accordingly, the base treated acid washed solution 178 may include deprotonated nitrogenous base. For example, responsive to contact with the base material in the packed column 174, the amine salt of the nitrogenous base may be replaced by the base material to form a sulfate of the base material and deprotonate the nitrogenous base, releasing the nitrogenous base from the amine sulfate salt. Responsive to deprotonation, the nitrogenous base may exhibit a reduced solubility in the aqueous phase of the base treated acid washed solution 178 facilitating the separation of the nitrogenous base from the base treated acid washed solution 178.

In embodiments where the packed column 174 includes calcium hydroxide, the acid washed solution 172 may react with the calcium hydroxide in the packed column 174 to form calcium sulfate and free the nitrogenous base from the amine sulfate salt. The base treated acid washed solution 178 may exhibit a substantially similar composition as the acid washed solution 172, except that the base treated acid washed solution 178 may include deprotonated nitrogenous base (and not include the amine sulfate salt) and may include some ionic species of the base material from the packed column 174 and/or precipitates thereof. The calcium sulfate may exhibit a relatively low solubility in the aqueous phase and may, therefore, precipitate out of the base treated acid washed solution 178. In some embodiments, the calcium sulfate remains in the packed column 174, such as on surfaces of the packing material (e.g., calcium hydroxide) of the packed column 174. Since the calcium sulfate precipitates out of solution, the base treated acid washed solution 178 may include a relatively low concentration of ionic species, facilitating recycling of the base treated acid washed solution 178 to the acid wash solution 164 to be reused in the acid wash column 162. By way of comparison, in carbon capture systems that utilize sodium hydroxide to facilitate the recovery of the nitrogenous base, the sodium sulfate is soluble in the aqueous phase, increasing the expense and difficulty associated with recovery of the water from the salt.

In some embodiments, the base treated acid washed solution 178 may be provided to a separator 180 configured to separate the nitrogenous base from the base treated acid washed solution 178 to form a recovered nitrogenous base 184 and an acid wash return 186. The acid wash return 186 may be substantially free of the nitrogenous base. The recovered nitrogenous base 184 may include the third portion of the nitrogenous base (or a second portion of the nitrogenous base in embodiments not including the condenser 130 and including the cooler 160). The separator 180 may be configured to separate the nitrogenous base from the acid in the base treated acid washed solution 178 using one or more separation techniques, such as liquid extraction with a solvent, distillation, gravity separation, cyclone separation, or combinations thereof. By way of non-limiting example, the separator 180 may include a solvent extraction vessel wherein the base treated acid washed solution 178 is contacted with a solvent to extract the nitrogenous base from the base treated acid washed solution 178 to form a solution including the solvent (such as diethyl ether) and the nitrogenous base and acid wash return 186 substantially free of the nitrogenous base. The nitrogenous base may be separated from the solvent in the solution by, for example, distillation, to form the recovered nitrogenous base 184. In other embodiments, the separator 180 includes a cyclone separator configured to separate the nitrogenous base from the treated acid washed solution 178 based on a difference in density between the nitrogenous base and the acid wash solution (e.g., the acid wash return 186).

The acid wash return 186 may include acid-base salts. With continued reference to FIG. 1, in some embodiments, the acid-base salts may be removed from the acid wash return 186 in a solids separator 188 configured to separate precipitates (e.g., such as calcium sulfate that may have escaped from the packed column 174) and other solids from the acid wash return 186. In some embodiments, the solids separator 188 includes a filter or a centrifuge. Solids 190 may be removed from the solids separator 188 and an acid wash recycle 192 may be recycled to the acid wash solution 164. The acid wash solution recycle 192 may be mixed with make-up acid 168 to form the acid wash solution 164.

Although not specifically described, the carbon capture system 100 may include piping configured to facilitate the transport of one or more of the materials described herein within the carbon capture system 100. In addition, the carbon capture system 100 may include valves 196, pumps 197, heat exchanges, heaters 198, coolers (e.g., interstage coolers 112, cooler 125, cooler 133), reboilers (e.g., reboiler 120), condensers (such as cooler 125), and/or additional process equipment to facilitate operation of the carbon capture system 100.

The carbon capture system 100 may exhibit a CO₂ removal capacity of at least about 85 weight percent of the CO₂ in the CO₂-containing gas 102, such as at least about 90 weight percent, at least about 95 weight percent, at least about 97 weight percent, at least about 98 weight percent, or at least about 99 weight percent of the CO₂ in the CO₂-containing gas 102. The carbon capture system 100 may be used to remove CO₂ from the any CO₂-containing material, such as post-combustion streams from fossil fuel or biofuel combustion, natural gas streams, respiration gases from closed environments, or other gases.

The carbon capture system 100 including the heat exchanger (e.g., the condenser 130, the cooler 160) for reducing the temperature of the CO₂-lean gas 106 may facilitate improved recovery of the nitrogenous base compared to carbon capture systems that do not include such heat exchangers. In addition, a larger amount of the nitrogenous base is recovered in the water wash column 148 and/or prior to the water wash column 148, reducing the amount of the nitrogenous base to be recovered by the acid wash column 162. Reducing the amount of the nitrogenous base to be recovered by the acid wash column 162 may reduce the amount of acid to be used for recovery of the nitrogenous base.

In addition to improving the amount of the nitrogenous base recovered, reducing the temperature of the CO₂-lean gas 106 may improve the recovery of CO₂ from the CO₂-containing gas 102. For example, the nitrogenous base that is entrained in the CO₂-lean gas 106 includes nitrogenous base that has not reacted with the CO₂ (and does not include carbamate species, since the nitrogenous base that absorbs CO₂ in the absorber forms carbamate species, which are not volatile and do not leave the absorber 104 in the CO₂-lean gas 106). As the nitrogenous base is condensed by the condenser 130, the mist separator 142, and/or the water wash column 148, the condensed nitrogenous base may absorb carbon dioxide present in the CO₂-lean gas 106 and/or the demisted CO₂-lean gas 146. When the recovered nitrogenous base is returned to the absorber 104 and/or the mixing tank 141, the nitrogenous base may include absorbed carbon dioxide, reducing the amount of carbon dioxide that is unrecovered by the carbon capture system 100.

In addition to removal of CO₂, the carbon capture system 100 may facilitate the removal of aerosols and particulate matter present in the CO₂-containing gas 102. Reducing the temperature of the CO₂-lean gas 106 with the condenser 130 and/or the cooler 160 may facilitate condensation of fine particles that may be present in the CO₂-lean gas 106, such as those present in the CO₂-containing gas 102 and carried through the absorber 104. The particles may act as nuclei (e.g., seeds) on which droplets condense responsive to cooling the CO₂-lean gas 106. As the condensation continues, the condensed droplets grow in size until they reach a size large enough to fall out of the CO₂-lean gas 106.

Further, the packed column 174 including the base material (e.g., calcium hydroxide) facilitates improved recovery of the nitrogenous base from the acid washed solution 172. For example, the packed column 174 increases the pH of the acid washed solution 172 to form the base treated acid washed solution 178. The higher pH of the base treated acid washed solution 178 facilitates improved separation of the nitrogenous base from the aqueous phase of the base treated acid washed solution 178, improving the recovery of the nitrogenous base.

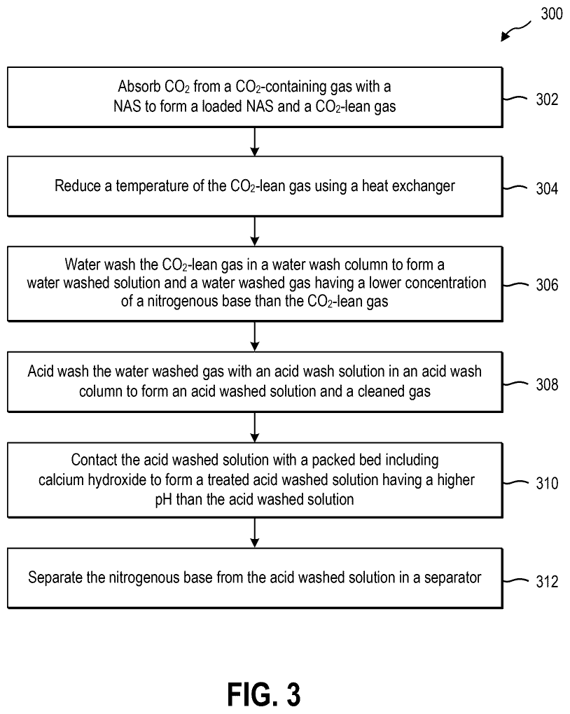

FIG. 3 is a simplified flow diagram illustrating a method of removing carbon dioxide from a CO₂-containing stream, according to at least one embodiment of the disclosure. The method 300 includes absorbing CO₂ from a CO₂-containing gas with a NAS to form a loaded NAS and a CO₂-lean gas, as shown in act 302. In some embodiments, act 302 includes contacting the CO₂-containing gas with a NAS in an absorber, as described above with reference to FIG. 1. The NAS may be the same as the NAS described above and may include a nitrogenous base, such as an amine. In some embodiments, the CO₂-lean gas includes at least some of the nitrogenous base therein.

Responsive to absorbing CO₂ from the CO₂-containing gas, the method 300 includes reducing a temperature of the CO₂-lean gas using a heat exchanger, as shown in act 304. The heat exchanger may include one or both of a condenser (e.g., condenser 130 (FIG. 1)) configured to reduce the temperature of the CO₂-lean gas, or a cooler (e.g., cooler 160 (FIG. 1)) configured to reduce a temperature of a water wash solution that is, in turn, used to water wash the CO₂-lean gas and reduce the temperature of the CO₂-lean gas. In some embodiments, act 304 includes reducing the temperature of the CO₂-lean gas to a temperature less than about 20° C., such as less than about 15° C., or less than about 10° C. In some embodiments, the act 304 includes reducing the temperature of the CO₂-lean gas to a temperature within a range of from about 10° C. to about 20° C.

The method 300 may further include water washing the CO₂-lean gas in a water wash column to form a water washed solution and a water washed gas having a lower concentration of the nitrogenous base than the CO₂-lean gas, as shown in act 306. In some embodiments, act 306 includes water washing the cooled CO₂-lean gas. In other embodiments, act 306 includes water washing the CO₂-lean gas with a water wash solution that has been cooled (e.g., during act 304). The water wash column, the washed liquid, and the water washed gas may be the same as described above with reference to FIG. 1. In some embodiments, the water washed gas includes a lower concentration of the nitrogenous base than the CO₂-lean gas, but may still include at least some of the nitrogenous base.

Responsive to water washing the CO₂-lean gas, the method 300 may further include acid washing the water washed gas with an acid wash solution in an acid wash column to form an acid washed solution and a cleaned gas, as shown in act 308. The acid wash column, the acid washed solution, and the cleaned gas may be the same as described above. The clean gas may have a lower concentration of the nitrogenous base than the acid washed gas. The acid washed solution may include the acid of the acid wash solution and at least a portion of the nitrogenous base captured by the acid wash solution in the acid wash column.

Responsive to acid washing the water washed gas, the method 300 further includes contacting the acid washed solution with a packed bed including calcium hydroxide to form a treated acid washed solution having a higher pH than the acid washed solution, as shown in act 310. The acid washed solution may be passed through a packed bed, such as the packed column 174 (FIG. 1). Passing the acid washed solution through the packed bed may increase the pH of the acid washed solution to greater than about 12.0, such as greater than about 13.0.

The method 300 may further include separating the nitrogenous base from the treated acid washed solution in a separator, as shown in act 312. The separator may be substantially the same as the separator 180 (FIG. 1).

While the method 300 has been described and illustrated as including reducing the temperature of the CO₂-lean gas in act 304 and contacting the acid washed solution with a packed bed including calcium hydroxide in act 310, the disclosure is not so limited. In some embodiments, the method 300 includes only one of act 304 or act 310.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A system for removing carbon dioxide from a carbon dioxide-containing gas, the system comprising:
an absorber configured to absorb carbon dioxide from the carbon dioxide-containing gas with a nitrogenous base to form a carbon dioxide-lean gas;
an acid wash column configured to remove the nitrogenous base from the carbon dioxide-lean gas with an acid wash solution and form an acid washed solution including the nitrogenous base; and
a packed bed including calcium hydroxide configured to deprotonate the nitrogenous base in the acid washed solution.

2. The system of claim 1, wherein the acid wash solution includes sulfuric acid.

3. The system of claim 1, wherein the packed bed is configured to increase a pH of the acid washed solution to at least 13.0.

4. The system of claim 1, wherein the packed bed is configured to form calcium sulfate responsive to contacting the acid washed solution.

5. The system of claim 1, further comprising a separator configured to separate the deprotonated nitrogenous base from the acid washed solution.

6. The system of claim 5, wherein the separator includes one of:
a cyclone separator; or
a solvent extraction separator configured to separate the nitrogenous base from the acid washed solution by solvent extraction.

7. The system of claim 1, further comprising a water wash column configured to contact the carbon dioxide-lean gas with a water wash solution to remove a first portion of the nitrogenous base from the carbon dioxide-lean gas and form a water washed gas having a lower concentration of the nitrogenous base than the carbon dioxide-lean gas, wherein the acid wash column is configured to remove a second portion of the nitrogenous base from the water washed gas.

8. The system of claim 1, further comprising one of:
a condenser configured to reduce a temperature of the carbon dioxide-lean gas to a temperature lower than about 20° C. before the acid wash column contacts the carbon dioxide-lean gas; and
a cooler configured to reduce a temperature of a water wash solution to a temperature lower than about 20° C.

9. The system of claim 1, wherein the absorber is configured to absorb carbon dioxide form the carbon dioxide-containing gas with a non-aqueous solvent including the nitrogenous base.

10. The system of claim 1, further comprising a regenerator configured to remove the carbon dioxide from the nitrogenous base after the nitrogenous base is loaded with carbon dioxide.

11. A system for removing carbon dioxide from a carbon dioxide-containing gas, the system comprising:
an absorber configured to absorb carbon dioxide from the carbon dioxide-containing gas with a non-aqueous solvent to form a carbon dioxide-lean gas having a lower concentration of carbon dioxide than the carbon dioxide-containing gas, wherein the non-aqueous solvent comprises a nitrogenous base;
an acid wash column configured to remove the nitrogenous base entrained in the carbon dioxide-lean gas with sulfuric acid to form an acid washed solution including the sulfuric acid and the nitrogenous base and an acid washed gas having a lower concentration of the nitrogenous base than the carbon dioxide-lean gas; and
a packed bed including calcium hydroxide configured to increase a pH of the acid washed solution.

12. The system of claim 11, wherein the non-aqueous solvent includes a polyether.

13. The system of claim 11, further comprising a separator configured to separate the nitrogenous base from the acid washed solution after increasing the pH of the acid washed solution in the packed bed.

14. The system of claim 11, further comprising a water wash column configured to remove a first portion of the nitrogenous base from the carbon dioxide-lean gas and form a water washed gas having a lower concentration of the nitrogenous base than the carbon dioxide-lean gas, wherein the acid wash column is configured to remove a second portion of the nitrogenous base from the water washed gas.

15. The system of claim 11, further comprising a condenser configured to reduce a temperature of the carbon dioxide-lean gas to a temperature less than about 20° C.

16. A method of removing carbon dioxide from a carbon dioxide-containing gas, the method comprising:
absorbing carbon dioxide from the carbon dioxide-containing gas in an absorber with a nitrogenous base to form a loaded absorbent including the carbon dioxide and a carbon dioxide-lean gas including entrained nitrogenous base;
removing the nitrogenous base from the carbon dioxide-lean gas with an acid wash solution to form an acid washed solution including the nitrogenous base and a cleaned gas having a lower concentration of the nitrogenous base than the carbon dioxide-lean gas; and
passing the acid washed solution through a packed bed including calcium hydroxide to deprotonate the nitrogenous base in the acid washed solution.

17. The method of claim 16, wherein passing the acid washed solution through a packed bed including calcium hydroxide includes increasing a pH of the acid washed solution to greater than 13.0.

18. The method of claim 16, wherein removing the nitrogenous base from the carbon dioxide-lean gas with an acid wash solution includes removing the nitrogenous base from the carbon dioxide-lean gas with an acid wash solution including sulfuric acid.

19. The method of claim 16, further comprising removing a first portion of the nitrogenous base from the carbon dioxide-lean gas with a water wash solution to form a water washed gas having a lower concentration of the nitrogenous base than the carbon dioxide-lean gas, wherein removing the nitrogenous base from the carbon dioxide-lean gas with an acid wash solution includes removing a second portion of the nitrogenous base from the water washed gas with the acid wash solution.

20. The method of claim 16, further comprising cooling the carbon dioxide lean-gas to a temperature lower than about 20° C.
